(19) United States
(12) Patent Application Publication
(10) Pub. No.: US 2019/0202507 A1
(43) Pub. Date: Jul. 4, 2019

(54) Vehicle Urging System

(71) Applicant: Rod Russell, Oak Grove, LA (US)

(72) Inventor: Rod Russell, Oak Grove, LA (US)

(21) Appl. No.: 15/861,141

(22) Filed: Jan. 3, 2018

(51) Int. Cl. B62D 55/02; B62D 55/24; B62D 33/073; B62D 55/04; B62D 55/205

(52) U.S. Cl. CPC B62D 55/02; B62D 55/24; B62D 55/205; B62D 55/04; B62D 33/073

(57) ABSTRACT

A vehicle urging system for inhibiting a vehicle from becoming high centered includes a vehicle that has a plurality of wheels and a bottom side. A track unit is coupled to the bottom side of the vehicle. The track unit engages an object that would otherwise high center the vehicle, such as a rock or the like. The track unit selectively rotates in a first direction to urge the vehicle along the object until the vehicle is clear of the object.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to urging devices and more particularly pertains to a new urging device for inhibiting a vehicle from becoming high centered.

### BRIEF SUMMARY OF THE INVENTION

An embodiment of the disclosure meets the needs presented above by generally comprising a vehicle that has a plurality of wheels and a bottom side. A track unit is coupled to the bottom side of the vehicle. The track unit engages an object that would otherwise high center the vehicle, such as a rock or the like. The track unit selectively rotates in a first direction to urge the vehicle along the object until the vehicle is clear of the object.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a track unit of a vehicle urging system according to an embodiment of the disclosure.

FIG. 2 is a front view of an embodiment of the disclosure.

FIG. 3 is a right side view of an embodiment of the disclosure.

FIG. 4 is a bottom view of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

### DETAILED DESCRIPTION OF THE INVENTION

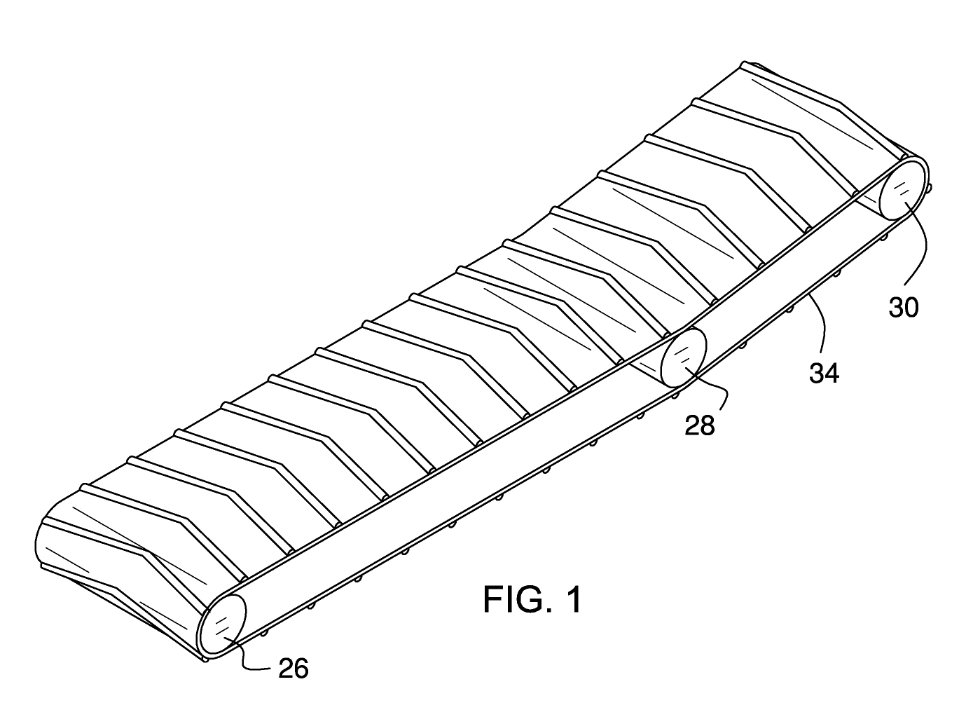

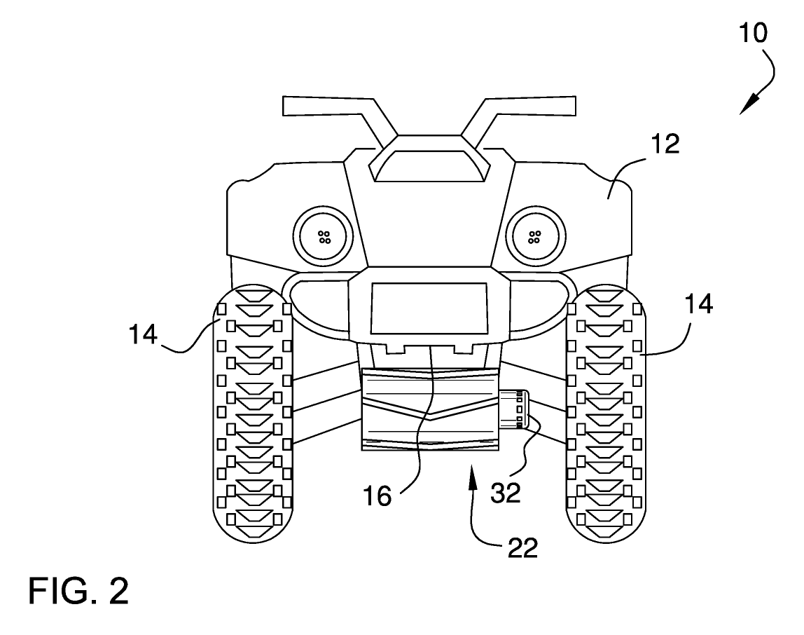

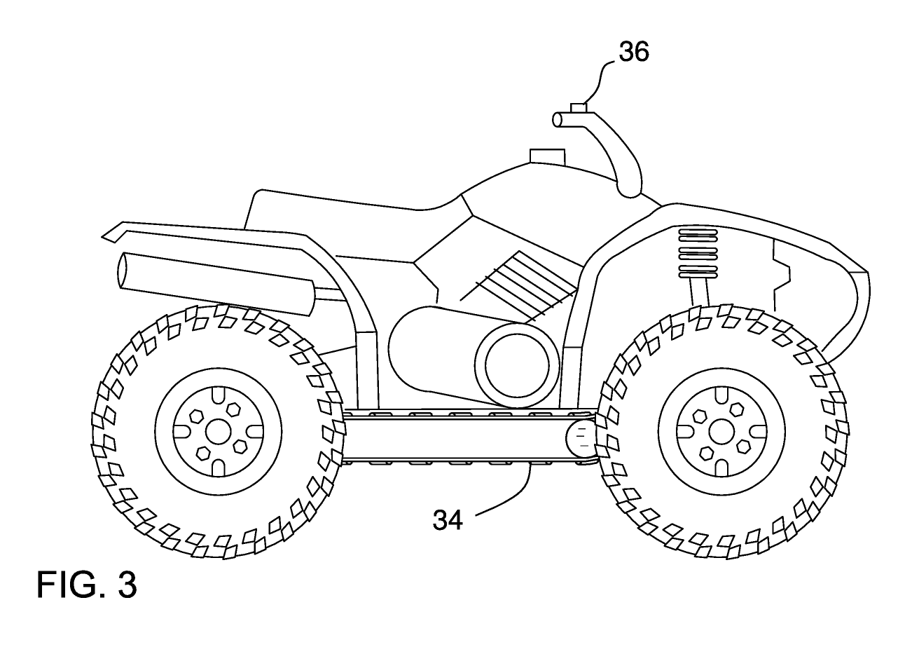

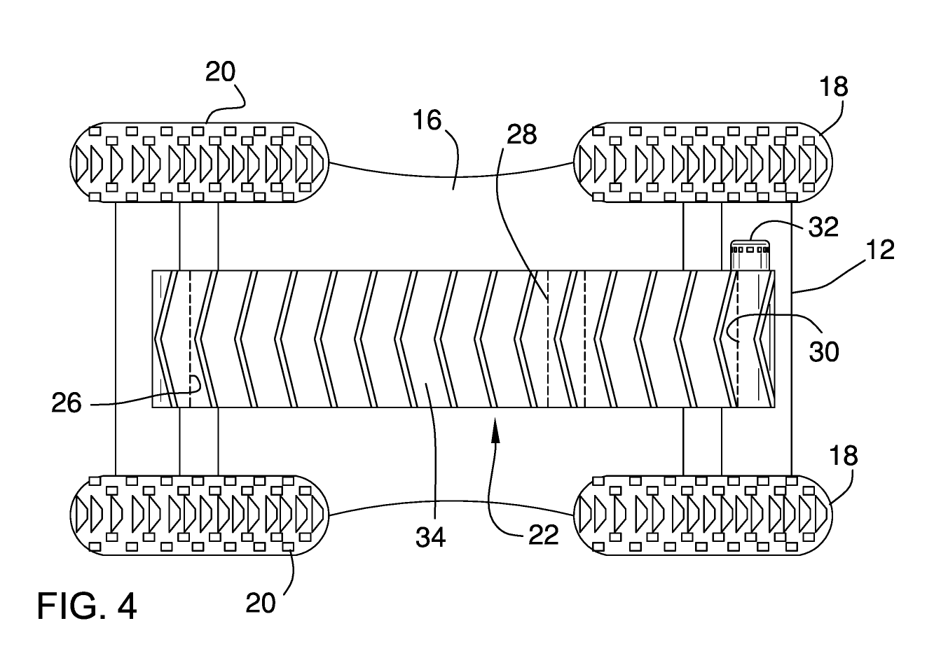

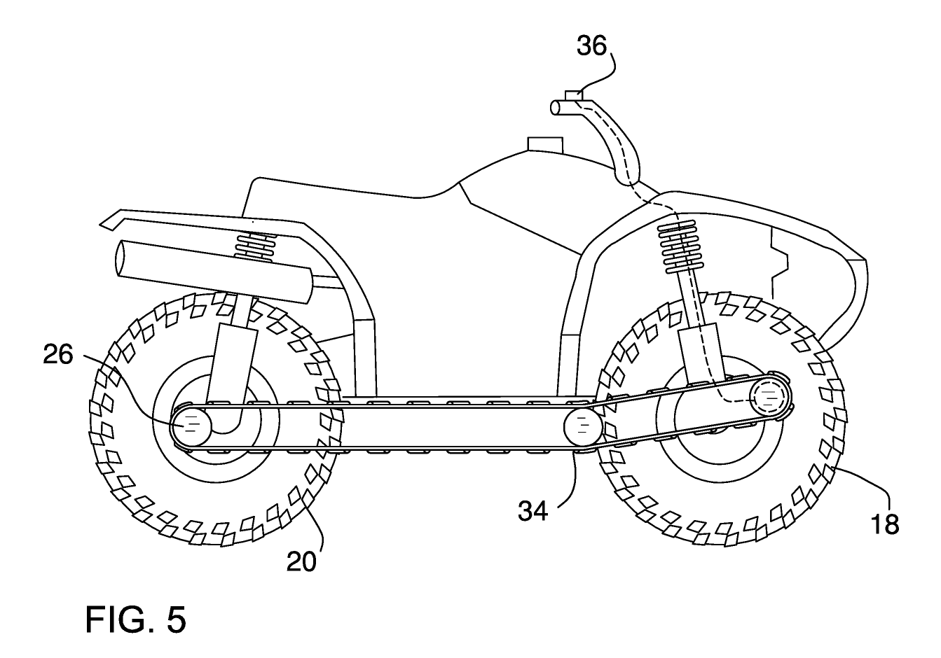

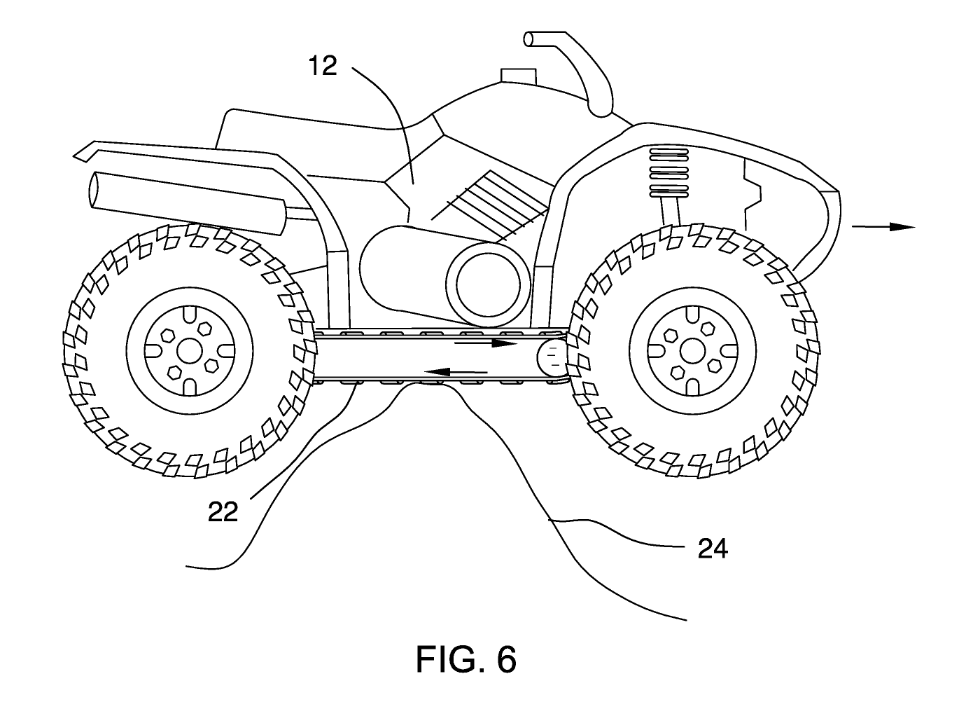

With reference now to the drawings, and in particular to FIGS. 1 through 6 thereof, a new urging device embodying the principles and concepts of an embodiment of the disclosure and generally designated by the reference numeral 10 will be described.

As best illustrated in FIGS. 1 through 6, the vehicle urging system 10 generally comprises a vehicle 12 that has a plurality of wheels 14 and a bottom side 16. The plurality of wheels 14 includes a set of front wheels 18 and a set of rear wheels 20. The vehicle 12 may be an off road vehicle such as an ATV or the like, an on road vehicle such as a pickup or the like and any other vehicle that can potentially become high centered. A track unit 22 is coupled to the bottom side 16 of the vehicle 12 to engage an object 24 that would otherwise high center the vehicle 12. The object 24 may be a rock and any other object 24 on the ground where the vehicle 12 is being driven. The track unit 22 selectively rotates in a first direction to urge the vehicle 12 along the object 24 until the vehicle 12 is clear of the object 24.

The track unit 22 comprises a first roller 26 that is rotatably coupled to the bottom side 16 of the vehicle 12. The first roller 26 is aligned with the set of rear wheels 20 and the first roller 26 rotates about an axis extending through each of the rear wheels 20. A second roller 28 is rotatably coupled to the bottom side 16 of the vehicle 12 and the second roller 28 is positioned between the rear wheels 20 and the front wheels 18. The second roller 28 is aligned with the first roller 26. Moreover, the second roller 28 is spaced between the front wheels 18 and the first roller 26 and the second roller 28 rotates about the axis.

A drive roller 30 is rotatably coupled to the bottom side 16 of the vehicle 12. The drive roller 30 is aligned with the set of front wheels 18 and the drive roller 30 rotates about the axis. A motor 32 is coupled to the vehicle 12 and the drive roller 30 is rotatably coupled to the motor 32 and the motor 32 rotates the drive roller 30 in a first direction when the motor 32 is turned on. The motor 32 may be an electric motor 32 or the like and the motor 32 may be coupled to the drive roller 30 via a shaft, gears and a chain, pulleys and a belt and any other conventional mechanical means of driving a roller with a motor. Each the first 26, second 28 and drive 30 rollers may include a mount and a cylinder being rotatably coupled the mount. The mount may be coupled to the bottom side 16 of the vehicle 12 such that the cylinder is spaced from the bottom side 16 of the vehicle 12. Additionally, each of the first 26 and second 28 rollers may include a plurality of wheels that are each rotatably coupled to the bottom side 16 of the vehicle 12.

A track 34 extends around the first roller 26, the second roller 28 and the drive roller 30. In this way the track 34 engages the object 24 when the vehicle 12 drives over the object 24 and becomes high centered on the object 24. The drive roller 30 rotates the track 34 when the motor 32 is turned on. In this way the track 34 urges the vehicle 12 over the object 24 when the vehicle 12 is high centered on the object 24. The track 34 may be a rubber drive track of any conventional design and the track 34 conforms to contours of the bottom side 16 of the vehicle 12 in the convention of a skid plate. A control 36 is coupled to the vehicle 12 and the control 36 turns the motor 32 on and off. The control 36 is electrically coupled to the electrical system of the vehicle 12 and the control 36 may include a switch or any other electronic means of controlling an electric motor 32.

In use, the vehicle 12 is driven in off road for the purposes of off road competition, hunting and any other reason that exposes the vehicle 12 to the potential of becoming high centered. The track 34 engages the object 24 when the vehicle 12 becomes high centered on the object 24. The control 36 is manipulated to turn the motor 32 on and thusly urge the vehicle 12 over the object 24 when the wheels 14 are not in contact with the ground. In this way the track 34 reduces the likelihood that the vehicle 12 will become stuck due to being high centered. The control 36 is manipulated to turn the motor 32 off when the vehicle 12 is no longer high centered and the vehicle 12 resumes conventional operation.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle urging system for moving a vehicle when said vehicle becomes high centered, said system comprising:
a vehicle having a plurality of wheels and a bottom side; and
a track unit being coupled to said bottom side of said vehicle wherein said track unit is configured to engage an object that would otherwise high center said vehicle, said track unit selectively rotating in a first direction wherein said track unit is configured to urge said vehicle along the object until said vehicle is clear of the object.

2. The system according to claim 1, wherein:
said plurality of wheels includes a set of front wheels and a set of rear wheels; and
said track unit comprises a first roller being rotatably coupled to said bottom side of said vehicle, said first roller being aligned with said set of rear wheels, said first roller rotating about an axis extending through each of said rear wheels.

3. The system according to claim 2, further comprising a second roller being rotatably coupled to said bottom side of said vehicle, said second roller being positioned between said rear wheels and said front wheels, said second roller being aligned with said first roller, said second roller being spaced between said front wheels and said first roller, said second roller rotating about said axis.

4. The system according to claim 1, further comprising a drive roller being rotatably coupled to said bottom side of said vehicle, said drive roller being aligned with said set of front wheels, said drive roller rotating about said axis.

5. The system according to claim 4, further comprising a motor being coupled to said vehicle, said drive roller being rotatably coupled to said motor such that said motor rotates said drive roller when said motor is turned on.

6. The system according to claim 5, further comprising a track extending around a first roller, a second roller and said drive roller wherein said track is configured to engage the object, said drive roller rotating said track when said motor is turned on wherein said track is configured to urge said vehicle over the object when the object lifts said wheels off of the ground.

7. The system according to claim 6, further comprising a control being coupled to said vehicle such that said control turns said motor on and off, said control being electrically coupled to said vehicle.

8. A vehicle urging system for moving a vehicle when said vehicle becomes high centered, said system comprising:
a vehicle having a plurality of wheels and a bottom side, said plurality of wheels including a set of front wheels and a set of rear wheels; and
a track unit being coupled to said bottom side of said vehicle wherein said track unit is configured to engage an object that would otherwise high center said vehicle, said track unit selectively rotating in a first direction wherein said track unit is configured to urge said vehicle along the object until said vehicle is clear of the object, said track unit comprising:
a first roller being rotatably coupled to said bottom side of said vehicle, said first roller being aligned with said set of rear wheels, said first roller rotating about an axis extending through each of said rear wheels;
a second roller being rotatably coupled to said bottom side of said vehicle, said second roller being positioned between said rear wheels and said front wheels, said second roller being aligned with said first roller, said second roller being spaced between said front wheels and said first roller, said second roller rotating about said axis;
a drive roller being rotatably coupled to said bottom side of said vehicle, said drive roller being aligned with said set of front wheels, said drive roller rotating about said axis;
a motor being coupled to said vehicle, said drive roller being rotatably coupled to said motor such that said motor rotates said drive roller when said motor is turned on;
a track extending around said first roller, said second roller and said drive roller wherein said track is configured to engage the object, said drive roller rotating said track when said motor is turned on wherein said track is configured to urge said vehicle over the object when the object lifts said wheels off of the ground; and
a control being coupled to said vehicle such that said control turns said motor on and off, said control being electrically coupled to said vehicle.
